(19) United States
(12) Patent Application Publication
(10) Pub. No.: US 2022/0118500 A1
(43) Pub. Date: Apr. 21, 2022

(54) DISPLAY DEVICE AND FORMING DEVICE

(71) Applicant: SUMITOMO HEAVY INDUSTRIES, LTD., Tokyo (JP)

(72) Inventors: Hiroyuki Kan, Ehime (JP); Noboru Itagaki, Ehime (JP); Norieda Ueno, Tokyo (JP)

(21) Appl. No.: 17/565,035

(22) Filed: Dec. 29, 2021

Related U.S. Application Data
(63) Continuation of application No. PCT/JP2020/030479, filed on Aug. 7, 2020.

(30) Foreign Application Priority Data
Aug. 15, 2019 (JP) 2019-149145

(51) Int. Cl. B21D 26/041; B21D 26/047

(52) U.S. Cl. CPC B21D 26/041; B21D 26/047

(57) ABSTRACT

Provided is a display device for a forming device that forms a heated metal material using a metal member. The display device proposes and displays a variable parameter that is adjustable.

### RELATED APPLICATIONS

The contents of Japanese Patent Application No. 2019-149145, and of International Patent Application No. PCT/JP2020/030479, on the basis of each of which priority benefits are claimed in an accompanying application data sheet, are in their entirety incorporated herein by reference.

### BACKGROUND

### Technical Field

Certain embodiments of the present invention relate to a display device and a forming device.

### Description of Related Art

In the related art, a forming device has been known which forms a metal pipe by heating a metal pipe material and by supplying gas into the heated metal pipe material to expand the heated metal pipe material. For example, in the related art, a forming device including a forming die including a lower die and an upper die paired with each other, a gas supply unit that supplies gas into a metal pipe material held in the forming die, and a heating unit that heats the metal pipe material through energization heating is disclosed.

### SUMMARY

According to one aspect of the present invention, there is provided a display device for a forming device that forms a heated metal material using a metal member. The display device proposes and displays a variable parameter that is adjustable.

According to another aspect of the present invention, there is provided a forming device that forms a heated metal material using a metal member. The forming device simultaneously forms a plurality of the metal materials, and the forming device includes a magnetic force adjusting member that adjusts magnetic forces acting on the plurality of metal materials.

According to still another aspect of the present invention, there is provided a forming device including the display device according to the one aspect.

### BRIEF DESCRIPTION OF THE DRAWINGS

FIG. 1 is a schematic view of a forming device.

FIG. 2A is a schematic side view illustrating a heating and expanding unit in which components such as a holding unit, a heating unit, and a fluid supply unit are unitized, and FIG. 2B is a cross-sectional view illustrating how a nozzle seals a metal pipe material.

FIG. 3 is a schematic cross-sectional view illustrating a part of the forming device when viewed in a longitudinal direction.

FIG. 4 is a schematic cross-sectional view illustrating a part of the forming device when viewed in the longitudinal direction.

FIG. 5 is an enlarged cross-sectional view illustrating the metal pipe material and a forming die of FIG. 4.

FIGS. 6A and 6B are enlarged cross-sectional views illustrating a state of the metal pipe material and the forming die during blow forming.

FIG. 7 is a flowchart illustrating contents of a forming method to be performed by the forming device.

FIG. 8 is a view illustrating one example of a rotating mechanism.

FIG. 9 is a view illustrating a robot arm including electrodes.

FIG. 10 is a schematic view of a forming device and a display device.

FIG. 11 is a view illustrating one example of display contents of the display device.

FIGS. 12A and 12B are views illustrating one example of display contents of the display device.

FIG. 13 is a model for calculating a load acting on a metal pipe material.

FIG. 14 is a view illustrating an example of calculation of a magnetic field for a metal pipe material.

FIG. 15 is a view illustrating an example of calculation of a magnetic field for a metal pipe material.

FIG. 16 is a view illustrating an example of calculation of a magnetic field for a metal pipe material.

FIG. 17 is a view illustrating an example of calculation of a magnetic field for a metal pipe material.

FIG. 18 is a schematic view of a forming device and a display device.

FIGS. 19A to 19C are views illustrating an example of disposition of a magnetic force adjusting member.

### DETAILED DESCRIPTION

In such a forming device of the related art, the metal pipe material is energized and heated to bring the metal pipe material into a high-temperature state. When the metal pipe material is energized and heated, a magnetic field is generated around the metal pipe material. In this case, a force acts to bring the lower die and the metal pipe material close to each other, and a force acts to bring the upper die and the metal pipe material close to each other. Here, a force of pulling to one die increases depending on a positional relationship between the lower die, the upper die, and the metal pipe material. In this case, deformation such as bending is generated in the metal pipe material that is heated and likely to be deformed, and the deformation may need to be prevented, or conversely, the metal pipe material may need to be formed in a desired shape using the deformation. In consideration of these matters, the disposing of a metal material such as a metal pipe material at an appropriate position with respect to metal members used for forming has been required.

It is desirable to provide a display device and a forming device that allow a metal material to be disposed at an appropriate position.

Such a display device proposes and displays the variable parameter that is adjustable. Accordingly, when the variable parameter is adjusted based on contents proposed by a user, the metal material can be disposed at a position at which the influence of a magnetic force is reduced. Accordingly, the metal material can be disposed at an appropriate position.

The variable parameter may be a parameter that affects a magnetic force acting on the metal material. Accordingly, the magnetic force on the metal material can be easily adjusted by adjusting the variable parameter.

The variable parameter may be a value of a current that energizes the metal material when the metal material is heated. A magnetic force on the metal material can be adjusted by adjusting the value of the current.

The forming device may simultaneously form a plurality of the metal materials, and the variable parameter may be a distance between the metal materials. Accordingly, magnetic forces acting on the metal materials can be adjusted.

The forming device may simultaneously form a plurality of the metal materials. A magnetic force adjusting member that adjusts magnetic forces acting on the metal materials may be disposed between the metal materials. The variable parameter may be a distance between the magnetic force adjusting member and the metal material. Accordingly, the magnetic force adjusting member is capable of adjusting the magnetic forces acting on the metal materials such that deformation of the metal materials is suppressed.

Such a forming device includes the magnetic force adjusting member that adjusts magnetic forces acting on the plurality of metal materials. Accordingly, the magnetic force adjusting member is capable of adjusting the magnetic forces acting on the metal materials such that deformation of the metal materials is suppressed. With the above configuration, the metal materials can be disposed at appropriate positions.

Hereinafter, exemplary embodiments of the present invention will be described with reference to the drawings. Incidentally, in the drawings, the same portions or equivalent portions are denoted by the same reference signs, and duplicated descriptions will be omitted.

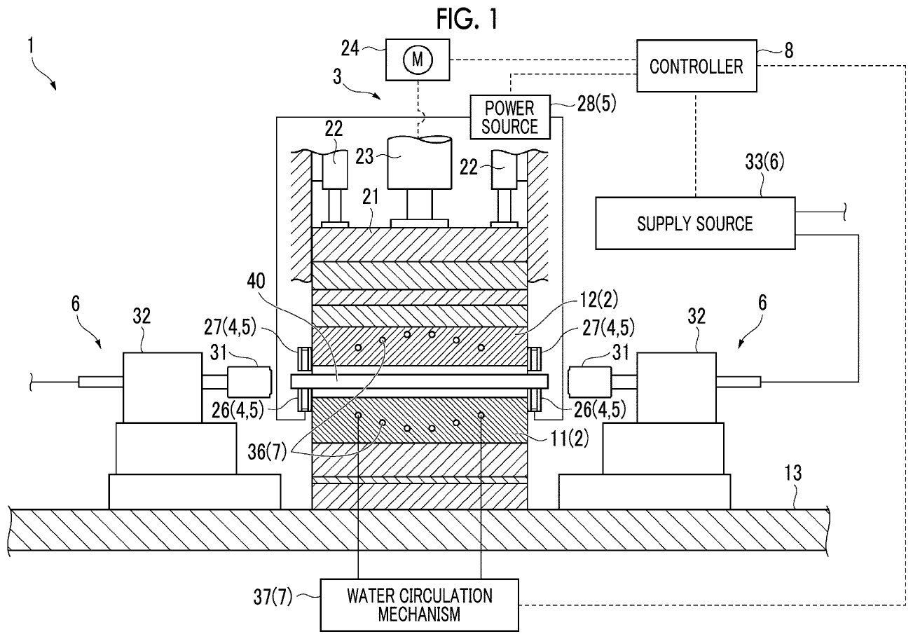

FIG. 1 is a schematic view of a forming device 1. As illustrated in FIG. 1, the forming device 1 is a device that forms a metal pipe having a hollow shape using blow forming. In the present embodiment, the forming device 1 is installed on a horizontal plane. The forming device 1 includes a forming die 2 (metal member), a drive mechanism 3, a holding unit 4, a heating unit 5, a fluid supply unit 6, a cooling unit 7, and a controller 8. Incidentally, in the specification, a metal pipe refers to a hollow article after completion of forming in the forming device 1, and a metal pipe material 40 (metal material) refers to a hollow article before completion of forming in the forming device 1. The metal pipe material 40 is a quenchable steel type pipe material. In addition, regarding a horizontal direction, a direction in which the metal pipe material 40 extends during forming may be referred to as a “longitudinal direction”, and a direction perpendicular to the longitudinal direction may be referred to as a “width direction”.

The forming die 2 is a die that forms the metal pipe material 40 into a metal pipe, and includes a lower die 11 (first die) and an upper die 12 (second die) facing each other in an up-down direction. Each of the lower die 11 and the upper die 12 are formed of a steel block. Each of the lower die 11 and the upper die 12 is provided with a recessed portion that accommodates the metal pipe material 40. In a state where the lower die 11 and the upper die 12 are in close contact with each other (die closed state), the recessed portions form a space having a target shape in which the metal pipe material has to be formed. Therefore, a surface of each of the recessed portions serves as a forming surface of the forming die 2. The lower die 11 is fixed to a base stage 13 via a die holder or the like. The upper die 12 is fixed to a slide of the drive mechanism 3 via a die holder or the like.

The drive mechanism 3 is a mechanism that moves at least one of the lower die 11 and the upper die 12. In FIG. 1, the drive mechanism 3 has a configuration of moving only the upper die 12. The drive mechanism 3 includes a slide 21 that moves the upper die 12 such that the lower die 11 and the upper die 12 are aligned with each other; a pull-back cylinder 22 as an actuator that generates a force to pull the slide 21 upward; a main cylinder 23 as a drive source that lowers and presses the slide 21; and a drive source 24 that imparts a driving force to the main cylinder 23.

The holding unit 4 is a mechanism that holds the metal pipe material 40 to be disposed between the lower die 11 and the upper die 12. The holding unit 4 includes a lower electrode 26 and an upper electrode 27 that hold the metal pipe material 40 on one end side in the longitudinal direction of the forming die 2, and a lower electrode 26 and an upper electrode 27 that hold the metal pipe material 40 on the other end side in the longitudinal direction of the forming die 2. The lower electrodes 26 and the upper electrodes 27 on both sides in the longitudinal direction interpose the vicinities of end portions of the metal pipe material 40 in the up-down direction to hold the metal pipe material 40. Incidentally, groove portions having a shape corresponding to an outer peripheral surface of the metal pipe material 40 are formed in an upper surface of the lower electrode 26 and a lower surface of the upper electrode 27, respectively. The lower electrode 26 and the upper electrode 27 are provided with a drive mechanism (not illustrated), and are movable independently in the up-down direction.

The heating unit 5 heats the metal pipe material 40. The heating unit 5 is a mechanism that energizes the metal pipe material 40 to heat the metal pipe material 40. The heating unit 5 heats the metal pipe material 40 between the lower die 11 and the upper die 12 in a state where the metal pipe material 40 is separated from the lower die 11 and the upper die 12. The heating unit 5 includes the lower electrodes 26 and the upper electrodes 27 on both sides in the longitudinal direction described above, and a power source 28 that causes a current to flow to the metal pipe material via the electrodes 26 and 27.

The fluid supply unit 6 is a mechanism that supplies a high-pressure fluid into the metal pipe material 40 held between the lower die 11 and the upper die 12. The fluid supply unit 6 expands the metal pipe material 40 by supplying a high-pressure fluid into the metal pipe material 40 that is heated into a high-temperature state by the heating unit 5. The fluid supply units 6 are provided on both end sides of the forming die 2 in the longitudinal direction. The fluid supply unit 6 includes a nozzle 31 that supplies a fluid from an opening portion of the end portion of the metal pipe material 40 into the metal pipe material 40; a drive mechanism 32 that causes the nozzle 31 to advance and retreat with respect to the opening portion of the metal pipe material 40; and a supply source 33 that supplies a high-pressure fluid into the metal pipe material 40 via the nozzle 31. The drive mechanism 32 brings the nozzle 31 into close contact with the end portion of the metal pipe material 40 in a state where sealing is secured during supply of the fluid and during exhausting of the fluid, and separates the nozzle 31 from the end portion of the metal pipe material 40 at other times. Incidentally, the fluid supply unit 6 may supply gas such as high-pressure air or an inert gas as the fluid.

The cooling unit 7 is a mechanism that cools the forming die 2. The cooling unit 7 cools the forming die 2 and thus is capable of rapidly cooling the metal pipe material 40 when the expanded metal pipe material 40 comes into contact with the forming surface of the forming die 2. The cooling unit 7 includes flow paths 36 formed inside the lower die 11 and the upper die 12, and a water circulation mechanism 37 that supplies cooling water to the flow paths 36 and circulates the cooling water therethrough.

The controller 8 is a device that controls an entirety of the forming device 1. The controller 8 controls the drive mechanism 3, the holding unit 4, the heating unit 5, the fluid supply unit 6, and the cooling unit 7. The controller 8 repeatedly performs an operation of forming the metal pipe material 40 with the forming die 2.

Specifically, the controller 8 controls conveyance means such as robot arm to dispose the metal pipe material 40 between the lower die 11 and the upper die 12 that are in an open state. Alternatively, the controller 8 may wait for a worker to dispose manually the metal pipe material 40 between the lower die 11 and the upper die 12. In addition, the controller 8 controls an actuator of the holding unit 4 and the like such that the metal pipe material 40 is supported by the lower electrodes 26 on both sides in the longitudinal direction and thereafter, the upper electrodes 27 are lowered to interpose the metal pipe material 40 between the upper electrodes 27 and the lower electrodes 26. In addition, the controller 8 controls the heating unit 5 to energize and heat the metal pipe material 40. Accordingly, a current flows through the metal pipe material 40 in an axial direction, and the metal pipe material 40 itself generates heat because of Joule heat caused by electric resistance of the metal pipe material 40 itself.

The controller 8 controls the drive mechanism 3 such that the upper die 12 is lowered close to the lower die 11 to close the forming die 2. On the other hand, the controller 8 controls the fluid supply unit 6 to seal the opening portions at both ends of the metal pipe material 40 with the nozzle 31 and to supply the fluid. Accordingly, the metal pipe material 40 softened by heating expands and comes into contact with the forming surface of the forming die 2. Then, the metal pipe material 40 is formed according to the shape of the forming surface of the forming die 2. Incidentally, when a metal pipe with a flange is formed, a part of the metal pipe material 40 is entered into a gap between the lower die 11 and the upper die 12, and then die closing is further performed and the entered portion is crushed to forma flange portion. When the metal pipe material 40 comes into contact with the forming surface, the metal pipe material 40 is rapidly cooled by the forming die 2 cooled by the cooling unit 7, so that the metal pipe material 40 is quenched.

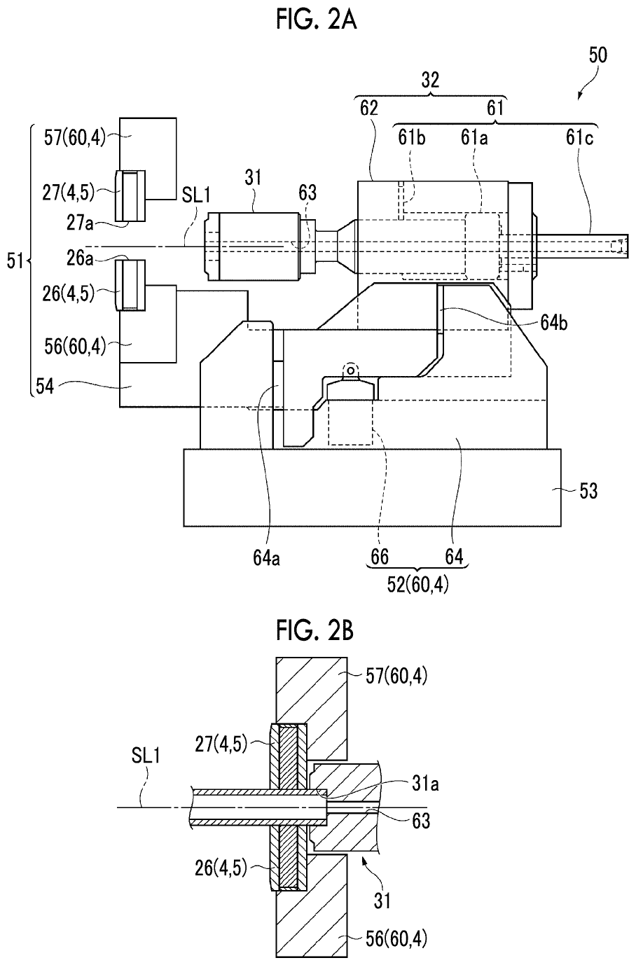

Next, a configuration of the forming device 1 will be described in further detail with reference to FIGS. 2A to 7. First, configurations of the holding unit 4, the heating unit 5, and the fluid supply unit 6 will be described in further detail with reference to FIGS. 2A and 2B. FIG. 2A is a schematic side view illustrating a heating and expanding unit 50 in which components such as the holding unit 4, the heating unit 5, and the fluid supply unit 6 are unitized. FIG. 2B is a cross-sectional view illustrating how the nozzle 31 seals the metal pipe material 40. Incidentally, FIGS. 2A and 2B illustrate the heating and expanding unit 50 for one end portion of the metal pipe material 40 in the longitudinal direction, and the heating and expanding unit 50 for the other end portion also has a configuration to the same effect.

As illustrated in FIG. 2A, the heating and expanding unit 50 includes the lower electrode 26, the upper electrode 27, an electrode mounting unit 51 on which the electrodes 26 and 27 are mounted, the nozzle 31, the drive mechanism 32, a lifting unit 52, and a unit base 53. Incidentally, the following description will be given on the premise that a reference line SL1 is set at the position of a center line of the metal pipe material 40 at a location at which the metal pipe material 40 is held by the electrodes 26 and 27. Incidentally, a direction in which the reference line SL1 extends may be referred to as the axial direction. In addition, a direction perpendicular to a facing direction of the electrodes 26 and 27 and to the axial direction may be referred to as a lifting direction.

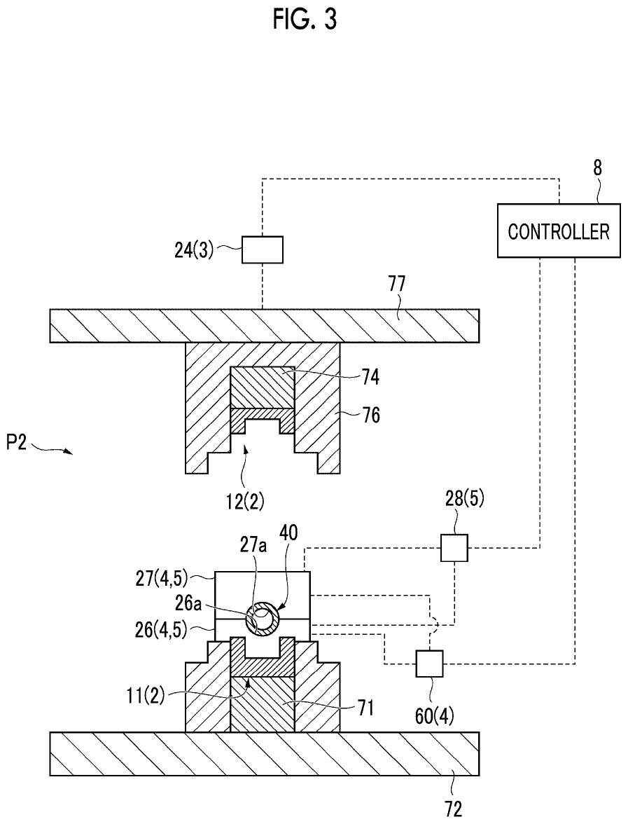

Both of the lower electrode 26 and the upper electrode 27 are rectangular flat plate-shaped electrodes, each of which is formed by interposing a plate-shaped conductor between insulating plates. A semicircular groove portion is formed in each of a central upper end portion of the lower electrode 26 and a central lower end portion of the upper electrode 27 so as to penetrate vertically through a flat plate surface. Then, when the lower electrode 26 and the upper electrode 27 are disposed on the same plane and an upper end portion of the lower electrode 26 and a lower end portion of the upper electrode 27 are brought into close contact with each other, the semicircular groove portions are combined together to form a circular through-hole. The circular through-hole has the reference line SL1 as a center line, and substantially coincides in outer diameter with the end portion of the metal pipe material 40. When the metal pipe material 40 is energized, the end portion of the metal pipe material 40 is gripped by the lower electrode 26 and the upper electrode 27 in a state where the end portion is fitted to the circular through-hole. In this case, inner peripheral surfaces 26a and 27a of the groove portions of the plate-shaped conductors of the lower electrode 26 and the upper electrode 27 are contact surfaces with respect to the metal pipe material 40, and are energized surfaces (refer to also FIG. 3). Incidentally, the outer shape of the end portion of the metal pipe material 40 is not limited to a circular shape. Therefore, each of the groove portions of the lower electrode 26 and the upper electrode 27 has the shape of a half split of the outer shape of the end portion of the metal pipe material 40.

The electrode mounting unit 51 includes a lifting frame 54 to which a lifting motion along a direction vertical to an upper surface of the unit base 53 is imparted by the lifting unit 52; a lower electrode frame 56 provided in the lifting frame 54 to hold the lower electrode 26; and an upper electrode frame 57 provided above the lower electrode frame 56 to hold the upper electrode 27. The electrode frames 56 and 57 each include an actuator and a guide mechanism (not illustrated), and is configured to be slidable in the axial direction and the lifting direction with respect to the unit base 53 in a state where the electrode frames 56 and 57 hold the electrodes 26 and 27, respectively. Therefore, each of the electrode frames 56 and 57 functions as a part of a drive mechanism 60 that moves each of the electrodes 26 and 27.

The nozzle 31 is a cylindrical member into which the end portion of the metal pipe material 40 can be inserted. The nozzle 31 is supported by the drive mechanism 32 such that a center line of the nozzle 31 coincides with the reference line SL1. An inner diameter of an end portion (referred to as a feed port 31a (refer to FIG. 2B)) of the nozzle 31 on a metal pipe material 40 side substantially coincides with an outer diameter of the metal pipe material 40 after expansion forming.

The drive mechanism 32 is mounted on the lifting unit 52. Therefore, when the lifting unit 52 makes a lifting motion, the drive mechanism 32 is raised and lowered integrally with the electrode mounting unit 51. The drive mechanism 32 supports the nozzle 31 at a position at which the end portion of the metal pipe material 40 and the nozzle 31 are concentric with each other in a state where the lower electrode 26 and the upper electrode 27 of the electrode mounting unit 51 grip the end portion of the metal pipe material 40.

The drive mechanism 32 includes a hydraulic cylinder mechanism as a nozzle-moving actuator that moves the nozzle 31 along the axial direction. The hydraulic cylinder mechanism includes a piston 61 (one example of a support portion) that holds the nozzle 31, and a cylinder 62 that causes the piston 61 to advance and retreat. The cylinder 62 is fixed to the lifting frame 54 in a direction in which the piston 61 advances and retreats parallel to the axial direction. The cylinder 62 is connected to a hydraulic circuit (not illustrated), and a pressure oil that is a working fluid is supplied into and discharged from the cylinder 62. The hydraulic circuit is controlled by the controller 8 to supply and discharge the pressure oil into and from the cylinder 62.

The piston 61 includes a main body 61a housed inside the cylinder 62; a head portion 61b protruding outward from a left end portion (lower electrode 26 and upper electrode 27 side) of the cylinder 62; and a pipe-shaped portion 61c protruding outward from a rear end portion of the cylinder 62. All of the main body 61a, the head portion 61b, and the pipe-shaped portion 61c have a cylindrical shape, and are concentrically and integrally formed. An outer diameter of the main body 61a substantially coincides with an inner diameter of the cylinder 62. Then, hydraulic pressures are supplied to both sides of the main body 61a to cause the piston 61 to advance and retreat inside the cylinder 62. The nozzle 31 is concentrically fixed and mounted on a tip portion of the head portion 61b. A flow path 63 for compressed gas is formed in the nozzle 31 and the piston 61 at the position of the reference line SL1 so as to penetrate therethrough over the total length thereof.

The lifting unit 52 includes a lifting frame base 64 attached to the upper surface of the unit base 53, and a lifting actuator 66 that imparts a lifting motion to the lifting frame 54 of the electrode mounting unit 51 via the lifting frame base 64. The lifting frame base 64 supports the lifting frame 54 so as to be liftable with respect to the upper surface of the unit base 53 in the lifting direction. The lifting frame base 64 includes guide portions 64a and 64b that guide the lifting motion of the lifting frame 54 with respect to the unit base 53. The lifting actuator 66 is a linear actuator that imparts a driving force to the lifting frame 54 with respect to the unit base 53, and for example, a hydraulic cylinder or the like can be used. Incidentally, the lifting unit 52 functions as a part of the drive mechanism 60 of the holding unit 4.

The unit base 53 is a rectangular plate-shaped block in a plan view that supports the electrode mounting unit 51 and the drive mechanism 32 on the upper surface thereof via the lifting unit 52. The unit base 53 is attached to an upper surface of the base stage 13 (refer to FIG. 1) that is a horizontal surface with fixing means such as bolts, and is removable. The heating and expanding unit 50 includes a plurality of the unit bases 53 of which upper surfaces have different inclination angles, and is capable of collectively changing and adjusting inclination angles of the lower electrode 26, the upper electrode 27, the nozzle 31, the electrode mounting unit 51, the drive mechanism 32, and the lifting unit 52 through replacement of the unit bases 53. For example, when the center line of the metal pipe material 40 is inclined in the end portion, the unit base 53 inclines each component such that the reference line SL1 is inclined according to the inclination.

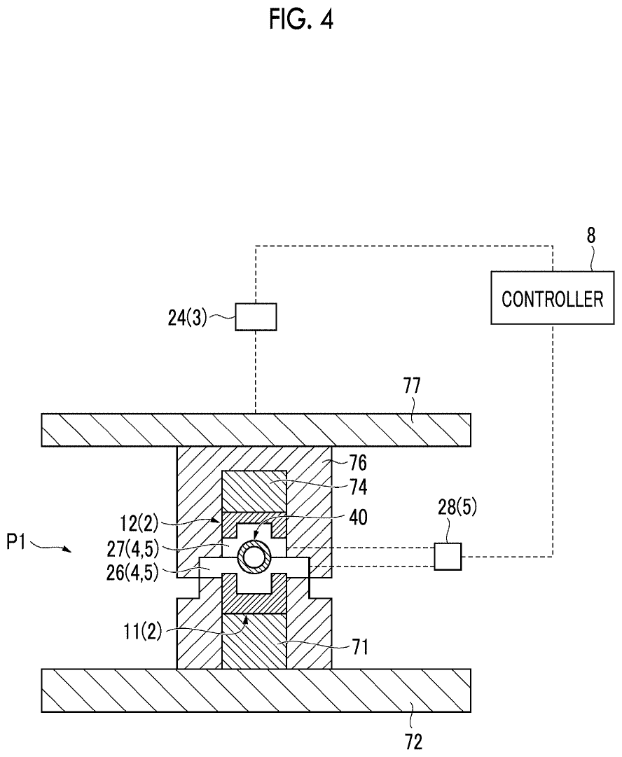

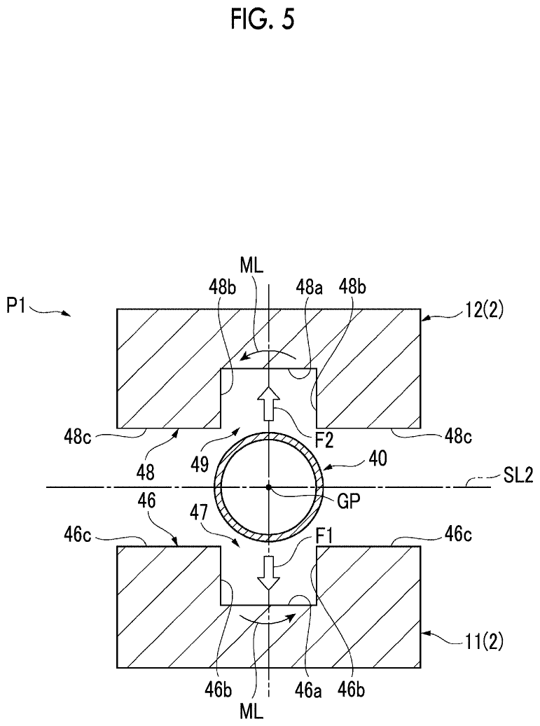

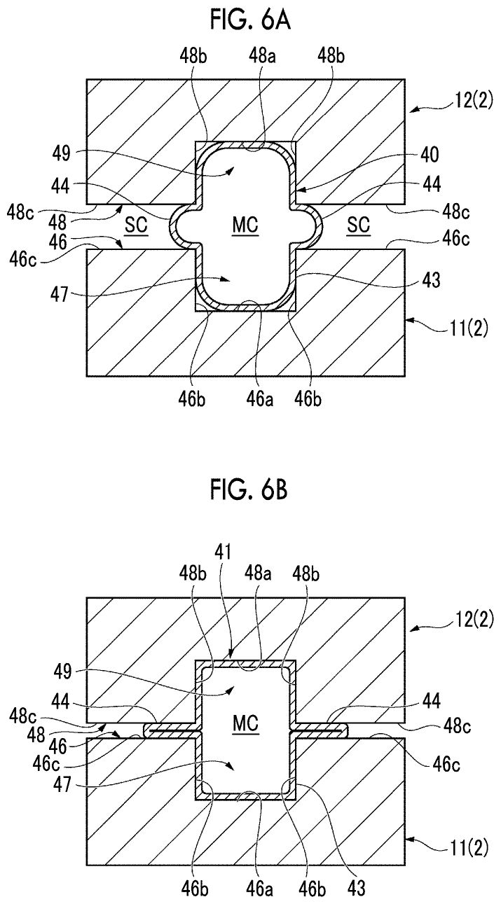

Next, control contents of the forming die 2 and the controller 8 will be described in further detail with reference to FIGS. 3 to 5. FIGS. 3 and 4 are schematic cross-sectional views illustrating a part of the forming device 1 when viewed in the longitudinal direction. FIG. 3 illustrates a positional relationship between the lower die 11, the upper die 12, and the metal pipe material 40 in a state where the metal pipe material 40 is disposed between the lower die 11 and the upper die 12 and the metal pipe material 40 is gripped by the lower electrode 26 and the upper electrode 27. FIG. 4 illustrates a positional relationship between the lower die 11, the upper die 12, and the metal pipe material 40 at a timing the metal pipe material 40 is energized and heated by the heating unit 5. Incidentally, in FIG. 4, since the position of each of the electrodes 26 and 27 is the same as that in FIG. 3, the drive mechanism 60 of the holding unit 4 is omitted. FIG. 5 is an enlarged cross-sectional view illustrating the metal pipe material 40 and the forming die 2 of FIG. 4. FIGS. 6A and 6B are enlarged cross-sectional views illustrating a state of the metal pipe material 40 and the forming die 2 during blow forming.

As illustrated in FIGS. 3 and 4, the lower die 11 is attached to a die holder plate 72 via a die holder 71. Both sides of the lower die 11 in the width direction are supported by die holders 73. The upper die 12 is attached to a die holder plate 77 via die holders 74 and 76. Both sides of the upper die 12 in the width direction are supported by the die holder 76.

FIGS. 5, 6A, and 6B illustrate an example of the forming die 2 when the metal pipe material 40 having a circular pipe shape as illustrated in FIG. 5 is formed into a metal pipe 41 including a pipe portion 43 having a rectangular pipe shape and flange portions 44 and 44 as illustrated in FIG. 6B. As illustrated in FIG. 5, a recessed portion 47 that is recessed downward is formed in an upper surface of the lower die 11 which is a forming surface 46. The forming surface 46 includes a bottom surface 46a of the recessed portion 47; side surfaces 46b and 46b of the recessed portion 47; and upper surfaces 46c and 46c disposed above the bottom surface 46a. A recessed portion 49 that is recessed upward is formed in a lower surface of the upper die 12 which is a forming surface 48. The forming surface 48 includes a bottom surface 48a of the recessed portion 49; side surfaces 48b and 48b of the recessed portion 49; and lower surfaces 48c and 48c disposed below the bottom surface 48a. As illustrated in FIG. 6A, a space surrounded by the recessed portions 47 and 49 is formed as a main cavity portion MC for forming the pipe portion 43. A space in which the upper surfaces 46c and 46c and the lower surfaces 48c and 48c face each other is formed as a subcavity portion SC for forming the flange portions 44 and 44.

The controller 8 is capable of controlling a positional relationship between the lower die 11, the upper die 12, and the metal pipe material 40 at a timing the metal pipe material 40 is input into the forming die 2 and during heating by transmitting control signals to the drive source 24 of the drive mechanism 3, the drive mechanism 60 of the holding unit 4, and the power source 28 of the heating unit 5. Therefore, the drive mechanism 3, the holding unit 4 (and the drive mechanism 60 thereof), and the controller 8 function as position adjusting unit that adjusts the position of the metal pipe material 40. The position adjusting unit adjusts the position of the metal pipe material 40 based on magnetic forces generated in a relationship of the forming die 2 to the metal pipe material 40. Incidentally, in the specification, “adjusting the position” of the metal pipe material 40 means adjusting the relative position of the metal pipe material 40 with respect to the forming die 2. Incidentally, the controller 8 includes a processor, a memory, a storage, a communication interface, and a user interface, and is configured as a general computer. The processor is an arithmetic and logic unit such as a central processing unit (CPU). The memory is a storage medium such as a read only memory (ROM) or random access memory (RAM). The storage is a storage medium such as a hard disk drive (HDD). The communication interface is a communication device that realizes data communication. The processor assumes overall control of the memory, the storage, the communication interface, and the user interface, and realizes functions to be described later. The controller 8 loads a program, which is stored in the ROM, into the RAM, and causes the CPU to execute the program loaded into the RAM to realize various functions. The controller 8 may be formed of a plurality of computers.

Here, the controller 8 is capable of causing the position of the metal pipe material 40 to be adjusted based on magnetic forces generated in the relationship between the forming die 2 and the metal pipe material 40 at a timing the metal pipe material 40 is heated by the heating unit 5. The controller 8 causes the position of the metal pipe material 40 to be adjusted such that magnetic forces on the metal pipe material 40 are balanced. The controller 8 is capable of controlling the positional relationship between the lower die 11, the upper die 12, and the metal pipe material 40 in consideration of an influence of a magnetic field generated around the metal pipe material 40 at a timing the metal pipe material 40 is heated by the heating unit 5. Namely, when energization heating causes a current to flow through the metal pipe material 40 in the axial direction, a magnetic field formed by a magnetic flux ML around the center line is generated around the metal pipe material 40 (refer to FIG. 5). Therefore, a force to pull the lower die 11 that is a conductor and the metal pipe material 40 against each other is generated therebetween. In addition, a force to pull the upper die 12 that is a conductor and the metal pipe material 40 against each other is generated therebetween. Therefore, the controller 8 performs control such that the lower die 11, the upper die 12, and the metal pipe material 40 are disposed at a first position P1 (refer to FIG. 4) at which the force generated between the lower die 11 and the metal pipe material 40 and the force generated between the upper die 12 and the metal pipe material 40 are balanced, and such that the metal pipe material 40 is heated at the first position P1 by the heating unit 5.

On the other hand, the influence between the metal pipe material 40 and the lower die 11 and between the metal pipe material 40 and the upper die 12 is small at times other than the timing the metal pipe material 40 is heated by the heating unit 5. Therefore, the controller 8 performs control such that the lower die 11, the upper die 12, and the metal pipe material 40 are disposed at a second position P2 (refer to FIG. 3) at which a positional relationship is established in which the metal pipe material 40 is disposed between the lower die 11 and the upper die 12 and which is different from the positional relationship at the balance position.

For example, as illustrated in FIG. 3, the controller 8 causes the upper die 12 to be sufficiently separated from the lower die 11 when the metal pipe material 40 is disposed between the lower die 11 and the upper die 12. In addition, the controller 8 controls the drive source 24 and the drive mechanism 60 such that the position of the lower electrode 26 is disposed at a position close to the lower die 11 and separated from the upper die 12. When the metal pipe material 40 is held by the lower electrodes 26, the lower die 11, the upper die 12, and the metal pipe material 40 are disposed at the second position P2. A separation distance between the upper die 12 and the metal pipe material 40 is larger than a separation distance between the lower die 11 and the metal pipe material 40 at the second position P2. Incidentally, in the specification, a state where the metal pipe material 40 is held includes not only a state where the metal pipe material 40 is gripped by the lower electrodes 26 and the upper electrodes 27, but also a state where the metal pipe material 40 is placed on the lower electrodes 26.

As illustrated in FIG. 4, the controller 8 sets the first position P1 such that the upper die 12 is closer to the metal pipe material 40 at the first position P1 than at the second position P2. The positions of the lower die 11 and the metal pipe material 40 are not changed when the metal pipe material 40 is input and when the metal pipe material 40 is heated. Therefore, the controller 8 causes the upper die 12 to be lowered to bring the upper die 12 close to the metal pipe material 40. Accordingly, a difference between the separation distance of the lower die 11 and the separation distance of the upper die 12 from the metal pipe material 40 at the first position P1 is smaller than that at the second position P2.

The first position P1 will be described in further detail with reference to FIG. 5. When a current flows through the metal pipe material 40 in the axial direction, a magnetic field formed by the magnetic flux ML is generated around the metal pipe material 40. The magnetic flux ML enters the lower die 11, so that a force F1 to pull the metal pipe material 40 to the lower die 11 acts on the metal pipe material 40. In addition, the magnetic flux ML enters the upper die 12, so that a force F2 to pull the metal pipe material 40 to the upper die 12 acts on the metal pipe material 40. In such a manner, the force F1 and the force F2 in opposite directions act on the metal pipe material 40. The first position P1 is a position at which the magnitudes of the force F1 and the force F2 acting on the metal pipe material 40 are substantially equal to each other.

In the present embodiment, since the metal pipe material 40 has a vertically symmetrical shape, the forming surface 46 and the forming surface 48 also have shapes that are vertically symmetrical to each other. Therefore, the separation distance of the lower die 11 from the metal pipe material 40 and the separation distance of the upper die 12 from the metal pipe material 40 are substantially the same at the first position P1. In this state, a separation distance of the upper surface 46c of the lower die 11 from a reference line SL2 that is horizontal and passes through a center of gravity GP of the metal pipe material 40, and a separation distance of the lower surface 48c of the upper die 12 from the reference line SL2 are substantially the same. In addition, in this state, a separation distance of the bottom surface 46a of the lower die 11 from the reference line SL2 and a separation distance of the bottom surface 48a of the upper die 12 from the reference line SL2 are substantially the same. In addition, in this state, a separation distance of a location at which the lower die 11 and the metal pipe material 40 are closest to each other and a separation distance of a location at which the upper die 12 and the metal pipe material 40 are closest to each other are substantially the same. However, at the first position P1, the forces F1 and F2 may be balanced, and the separation distance of the lower die 11 from the metal pipe material 40 and the separation distance of the upper die 12 from the metal pipe material 40 do not necessarily have to be strictly the same, and one of the separation distances may be larger than the other.

The controller 8 acquires position information of the first position P1 at which the forces F1 and F2 are balanced. The controller 8 controls the drive source 24 based on the acquired position information. The position information is acquired by analyzing magnetic fields between the metal pipe material 40 and the lower die 11 and between the metal pipe material 40 and the upper die 12. In the magnetic field analysis, a distribution of a magnetic field generated around the metal pipe material 40 and a positional relationship between the lower die 11, the upper die 12, and the metal pipe material 40 are analyzed to compute what positional relationship reduces the difference between the magnitudes of the force F1 and the force F2 acting on the metal pipe material 40. Incidentally, such a magnetic field analysis may be executed in advance before forming in the forming device 1 is started. In this case, position information of the first position P1 obtained from a result of the magnetic field analysis obtained in advance is stored in a storage unit of the controller 8. When the controller 8 controls the drive source 24, the controller 8 reads out the position information of the first position P1 from the storage unit. Alternatively, the controller 8 may actually cause a magnetic field to be measured, the magnetic field being generated around the metal pipe material 40, and perform a magnetic field analysis based on the measurement result.

Incidentally, the force F1 generated between the lower die 11 and the metal pipe material 40 and the force F2 generated between the upper die 12 and the metal pipe material 40 may have strictly the same magnitude at the first position P1. Namely, even in a case where one of the force F1 and the force F2 is larger than the other, when a difference therebetween is within an allowable range set in advance, it can be considered that the force F1 and the force F2 are in a balanced state.

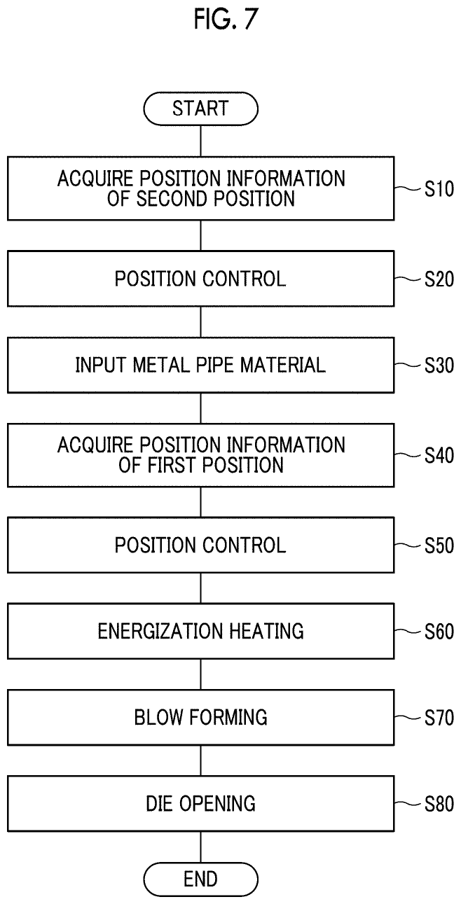

Next, a procedure of a forming method to be performed by the forming device 1 will be described with reference to FIG. 7. FIG. 7 is a flowchart illustrating contents of the forming method to be performed by the forming device 1. The controller 8 acquires position information of the second position P2 (step S10). Next, the controller 8 controls the position of each component such that the lower die 11, the upper die 12, and the metal pipe material 40 (assumed to be disposed on the lower electrodes 26) are located at the second position P2, based on the position information acquired in step S10 (step S20). Next, the controller 8 controls a robot arm and the like to dispose the metal pipe material 40 on the lower electrodes 26, so that the metal pipe material 40 is input between the lower die 11 and the upper die 12 (step S30). After the input, the controller 8 causes the upper electrodes 27 to be lowered, so that the metal pipe material 40 is gripped by the electrodes 26 and 27.

Next, the controller 8 acquires position information of the first position P1 (step S40). Next, the controller 8 controls the position of each component such that the lower die 11, the upper die 12, and the metal pipe material 40 are located at the first position P1, based on the position information acquired in step S40 (step S50). In step S50, the controller 8 causes the upper die 12 to be lowered to bring the upper die 12 to the metal pipe material 40 (refer to FIG. 4). Next, the controller 8 controls the heating unit 5 to energize and heat the metal pipe material 40 (step S60). Incidentally, the controller 8 may cause energization heating to be started after each component is located at the first position P1, but may cause energization heating to be started in the middle of a shift from the second position P2 to the first position P1. Namely, an influence of the difference between the forces F1 and F2 on the metal pipe material 40 is larger when the material is softened at the end of heating than when heating is started. Therefore, the shift to the first position P1 may be completed until the metal pipe material 40 is softened.

Next, the controller 8 causes the forming die 2 to be closed, and causes the fluid supply unit 6 to supply a fluid to the metal pipe material 40 to perform blow forming (step S70). In step S70, the controller 8 causes the main cavity portion MC to form the pipe portion 43, and causes a portion corresponding to the flange portion 44 to enter the subcavity portion SC (refer to FIG. 6A). Then, the controller 8 causes the forming die 2 to be further closed, and causes the portion, which has entered the subcavity portion SC, to be further crushed to form the flange portion 44. Next, the controller 8 causes the upper die 12 to be raised to separate the upper die 12 from the metal pipe material 40, so that die opening is performed (step S80). When step S80 ends, the process is repeated again from step S10.

Next, actions and effects of the forming device 1 will be described.

The forming device 1 includes the forming die 2 that is a metal member used to form the metal pipe material 40 which is a metal material, and the holding unit 4 that adjusts the position of the metal pipe material 40. During forming, when the holding unit 4 disposes the metal pipe material 40 close to the forming die 2, there is a possibility that magnetic forces are generated in a relationship of the forming die 2 to the metal pipe material 40. In this situation, the holding unit 4 adjusts the position of the metal pipe material 40 based on the magnetic forces generated in the relationship between the forming die 2 and the metal pipe material 40. Accordingly, the forming device 1 allows the metal pipe material 40 to be disposed at an appropriate position with respect to the forming die 2 used for forming.

The holding unit 4 adjusts the position of the metal pipe material 40 such that the magnetic forces on the metal pipe material 40 are balanced. Accordingly, bending of the metal pipe material caused by the magnetic forces can be suppressed.

The forming device 1 includes the forming die 2 including the lower die 11 and the upper die 12, and the heating unit 5 that energizes the metal pipe material 40 to heat the metal pipe material 40. Therefore, when the metal pipe material 40 is energized and heated by the heating unit 5, the force F1 is generated between the lower die 11 and the metal pipe material 40, and the force F2 is generated between the upper die 12 and the metal pipe material 40 because of the influence of a magnetic field generated around the metal pipe material 40. For example, as a comparative example, when energization heating is performed at the second position P2 as illustrated in FIG. 3, the separation distance between the upper die 12 and the metal pipe material 40 is large, so that the force F1 is considerably larger than the force F2. Therefore, the metal pipe material 40 that is likely to be bent at high temperature is pulled to the lower die 11. As a result, there is a possibility that deformation such as bending is generated in the metal pipe material 40.

On the other hand, in the forming device 1, the controller 8 causes the lower die 11, the upper die 12, and the metal pipe material 40 to be disposed at the first position P1 at which the force F1 generated between the lower die 11 and the metal pipe material 40 and the force F2 generated between the upper die 12 and the metal pipe material 40 are balanced, and causes the heating unit 5 to heat the metal pipe material 40 at the first position P1. Therefore, a defect can be reduced which is generated because of the metal pipe material 40 being pulled to one die when the heating unit 5 performs energization heating.

The controller 8 causes the lower die 11, the upper die 12, the metal pipe material 40 to be disposed at the second position P2 at which a positional relationship is established in which the metal pipe material 40 is disposed between the lower die 11 and the upper die 12 and which is different from the positional relationship at the first position P1. In this case, in processes other than the energization heating, the lower die 11, the upper die 12, and the metal pipe material 40 can be disposed at a position suitable for each of the processes. For example, in a process of inputting the metal pipe material 40 between the lower die 11 and the upper die 12, the upper die 12 can be separated upward such that the metal pipe material 40 is easily disposed on the lower electrodes 26.

At the second position P2, the upper die 12 is disposed at a position farther from the metal pipe material 40 than the position of the lower die 11, and the controller 8 may set the first position P1 such that the upper die 12 is closer to the metal pipe material 40 at the first position P1 than at the second position P2. Accordingly, the controller 8 is capable of causing the lower die 11, the upper die 12, and the metal pipe material 40 to be disposed at the first position P1 simply by causing the upper die 12 to be close to the metal pipe material 40 without requiring to control the electrodes 26 and 27 and the like.

The present invention is not limited to the above-described embodiment.

In the above-described embodiment, the metal pipe material is a straight pipe extending straight in the longitudinal direction, but a two-dimensionally bent pipe or a three-dimensionally bent pipe may be adopted. In addition, the outer shape of a cross section of the metal pipe material is a circular shape, but the shape is not particularly limited and may be an elliptical shape, a flat shape, or a polygonal shape. Even when the metal pipe material has such a shape, a position at which the positional relationship is established such that the force F1 and the force F2 acting on the metal pipe material 40 are balanced is defined as the first position P1.

In the above-described embodiment, only the upper die 12 is moved during a shift from the second position P2 to the first position P1. Instead thereof or in addition thereto, the motion of the electrodes 26 and 27 may be controlled to move the metal pipe material 40 upward or to move the lower die 11 downward. Alternatively, the lower die 11, the upper die 12, and the metal pipe material may be complexly moved to be shifted from the second position P2 to the first position P1.

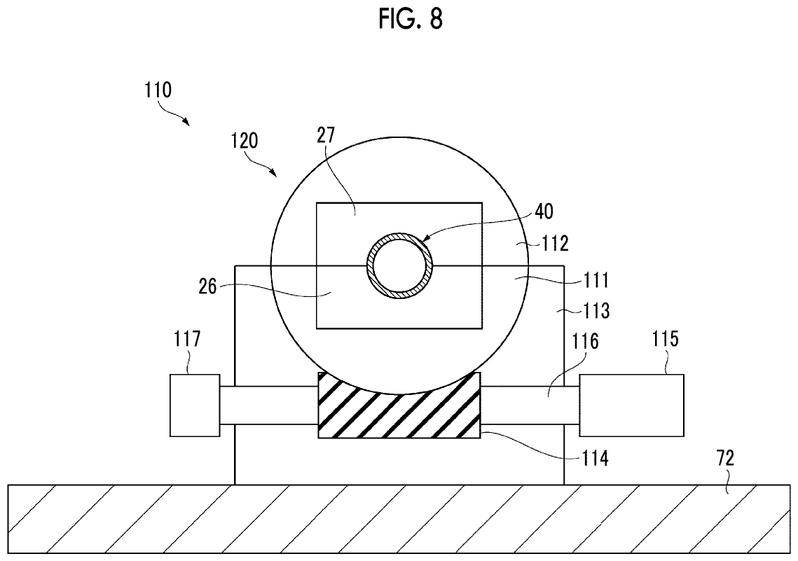

The holding unit 4 may include a rotating mechanism 110 that rotates the metal pipe material 40 between the lower die 11 and the upper die 12. For example, the rotating mechanism 110 as illustrated in FIG. 8 may be adopted. The rotating mechanism 110 includes rotary wheel frame members 111 and 112 provided on outer periphery sides of the electrodes 26 and 27, respectively. The rotary wheel frame members 111, 112 form a rotary wheel frame 120 having a circular shape when the electrodes 26 and 27 are closed. The rotary wheel frame members 111 and 112 are rotatably supported by a fixed frame 113 fixed to the die holder plate 72. The fixed frame 113 is disposed on both sides of the lower die 11. In addition, the fixed frame 113 is provided with a worm shaft 114 that rotates the rotary wheel frame 120, a motor 115 that rotates the worm shaft 114, a shaft 116 connecting the motor 115 and the worm shaft 114, and a position detector 117 that detects the rotation position of the rotary wheel frame.

The rotating mechanism 110 is capable of rotating the metal pipe material 40 by rotating the rotary wheel frame 120 after the metal pipe material 40 is gripped by the electrodes 26 and 27. Incidentally, energization heating may be started after the rotation of the rotary wheel frame 120 is completed, but energization heating may be started during rotation and the rotation may be completed before the material is softened. Incidentally, the rotating speed of the rotary wheel frame 120 is approximately 1 to 90°/sec.

In such a manner, the rotating mechanism 110 is capable of balancing the force F1 generated between the lower die 11 and the metal pipe material 40 and the force F2 generated between the upper die 12 and the metal pipe material 40 by rotating the metal pipe material 40. The rotating mechanism 110 can be effectively used when the metal pipe material 40 is bent in the longitudinal direction or when the cross-sectional shape thereof is a shape other than a circular shape.

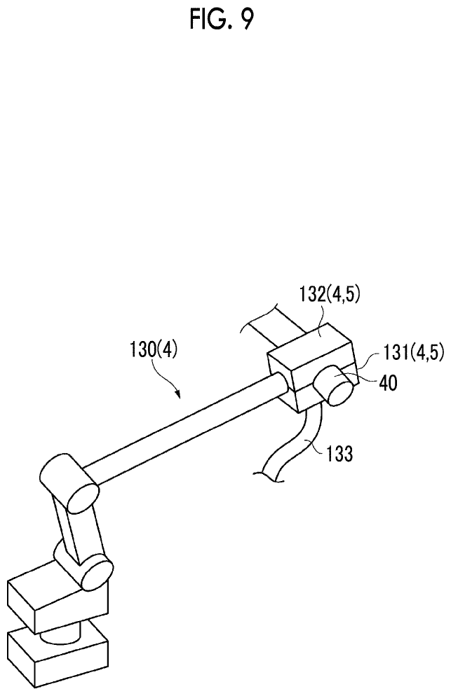

As illustrated in FIG. 9, the holding unit 4 may include a robot arm 130 that moves the metal pipe material 40 to a space between the lower die 11 and the upper die 12 from the outside of the forming die 2. In addition, the robot arm 130 may include the heating unit 5 that heats the metal pipe material 40 in a state where the metal pipe material 40 is held. The robot arm 130 includes an upper electrode 131 and a lower electrode 132 at a tip thereof. The robot arm 130 is capable of holding the metal pipe material 40 with the electrodes 131 and 132 in an interposed manner, and of energizing and heating the metal pipe material 40 with electric power from an electric power supply cable 133. The robot arm 130 may dispose the metal pipe material 40 at the first position P1. For example, the robot arm 130 disposes the metal pipe material 40 in the vicinity of a center position between the lower die 11 and the upper die 12 illustrated in FIG. 3, and performs energization heating at the position. Since separation distances of the lower die 11 and the upper die 12 from the metal pipe material 40 are substantially the same at the position, the position is the first position at which the force F1 and the force F2 are balanced. Accordingly, the robot arm 130 is capable of performing energization heating at the same time the robot arm 130 disposes the metal pipe material 40 between the lower die 11 and the upper die 12.

Incidentally, in the above-described embodiment, the fluid supply unit 6 supplies gas as a fluid, but may supply a liquid.

In the above-described embodiment, the forming die 2 is formed of the lower die 11 and the upper die 12, but may further include a die from a lateral side. In addition, the longitudinal direction of the forming die 2 is the horizontal direction, but is not particularly limited and a direction inclined with respect to the horizontal direction or a vertical direction may be adopted as the longitudinal direction.

In the above-described embodiment, the holding unit 4 adjusts the position of the metal pipe material 40 such that magnetic forces on the metal pipe material 40 are balanced. Instead thereof, the holding unit 4 may adjust the position of the metal pipe material 40 such that magnetic forces on the metal material are not balanced. In this case, the magnetic forces act on the metal pipe material 40 in such a way to be biased in one direction. Accordingly, the metal pipe material 40 can be bent in a desired direction. For example, the holding unit 4 disposes the lower die 11, the upper die 12, and the metal pipe material 40 at a position at which the force F1 generated between the lower die 11 and the metal pipe material 40 and the force F2 generated between the upper die 12 and the metal pipe material 40 are not balanced, and the heating unit 5 heats the metal pipe material 40 at the position. In this case, when the position is adjusted such that the force F1 is increased, the metal pipe material 40 can be bent upward. When the position is adjusted such that the force F2 is increased, the metal pipe material 40 can be bent downward.

In addition, in the above-described embodiment, the metal pipe material has been provided as an example of the metal material, but is not limited thereto. For example, a metal plate material or the like may be adopted as the metal material. In addition, the forming die has been provided as an example of a metal member that generates a magnetic force between the metal material and the metal member, but is not limited thereto. For example, as the metal member in which the generation of a magnetic force considered, a magnetic force may be considered which is generated in a relationship of a pin that supports the metal material to a shield member (made of iron) that prevents pipe fragments from flying during forming of a flange.

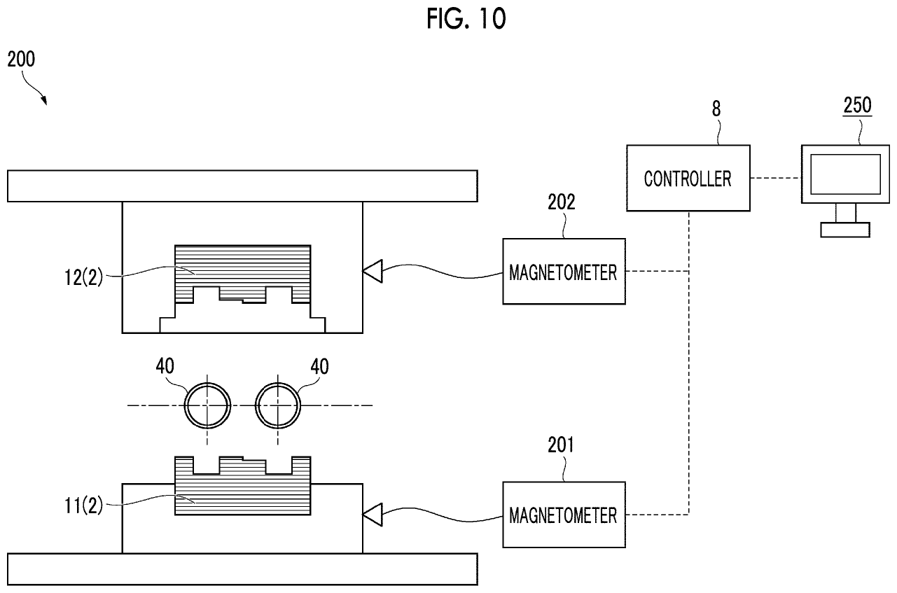

A forming device 200 illustrated in FIG. 10 may be adopted. The forming device 200 includes the forming die 2; a magnetometer 201 that measures a magnetic force of a lower die 11 side; a magnetometer 202 that measures a magnetic force of an upper die 12 side; the controller 8; and a display device 250. The forming die 2 is capable of simultaneously forming a plurality (here, two) of the metal pipe materials 40 arranged parallel to each other. In the forming die 2, the metal pipe materials 40 that are heated are disposed between the lower die 11 and the upper die 12 in a state where a processing distance is spaced therebetween in the width direction. The magnetometers 201 and 202 are capable of measuring magnetic forces around the forming die 2.

The display device 250 is a device that displays various information regarding the forming device 200. The display device 250 may be formed of an operation panel provided for the forming device 200, or may be formed of another PC.

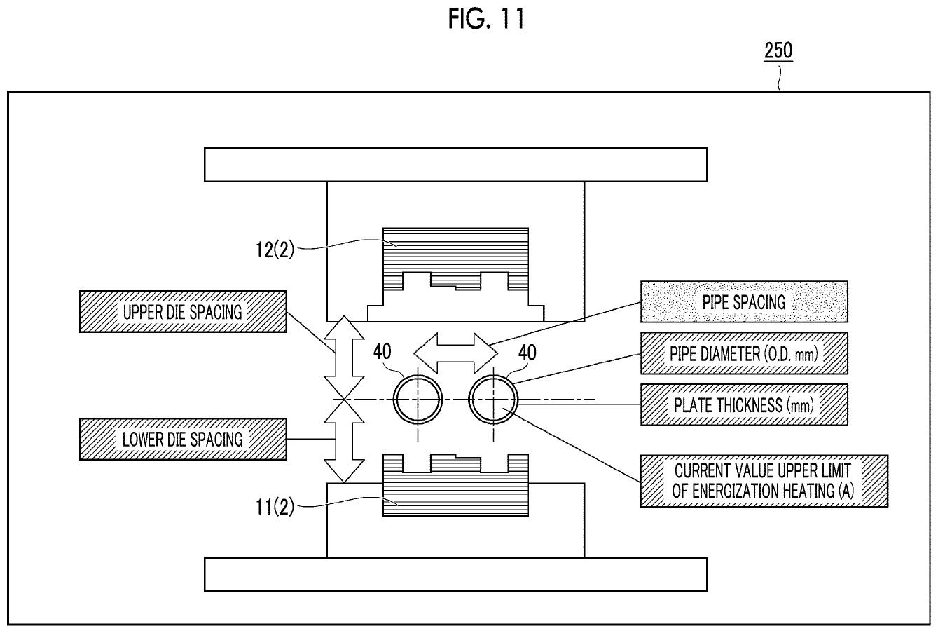

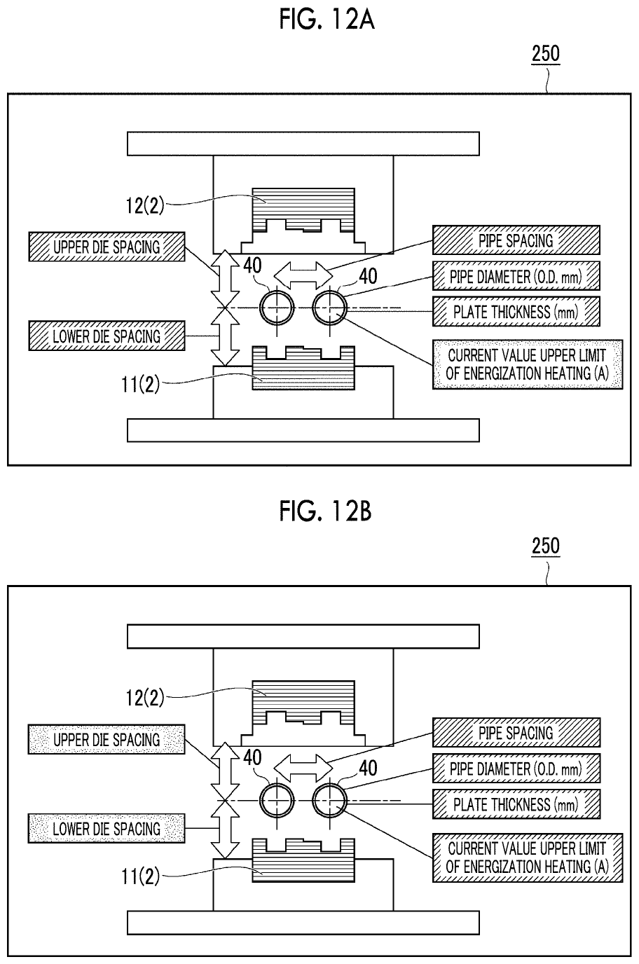

Here, one example of display contents of the display device 250 will be described with reference to FIG. 11. FIGS. 11, 12A, and 12B are views illustrating one example of display contents of the display device 250. The display device 250 displays parameters that affect a magnetic force acting on the metal pipe material 40. Particularly, the display device 250 proposes and displays variable parameters that are adjustable among the parameters that affect the magnetic force acting on the metal pipe material 40.

Specifically, as illustrated in FIGS. 11, 12A, and 12B, examples of the parameters that affect the magnetic force acting on the metal pipe material 40 include “pipe diameter”, “plate thickness”, “current value”, “pipe spacing”, “upper die spacing”, and “lower die spacing”. The “pipe diameter” is an outer diameter of the metal pipe material 40. The “plate thickness” is a thickness of a plate forming the metal pipe material 40. The “current value” is a value of a current that energizes the metal pipe material 40 when the metal pipe material 40 is heated. The “pipe spacing” is a distance between a pair of the metal pipe materials 40 arranged parallel to each other. The “upper die spacing” is a distance between the center of the metal pipe material 40 and the upper die 12. The “lower die spacing” is a distance between the center of the metal pipe material 40 and the lower die 11. Incidentally, any position of the metal pipe material 40 may serve as a reference for the “pipe spacing”, the “upper die spacing”, and the “lower die spacing”. In the examples illustrated in FIGS. 11, 12A, and 12B, the center position of the metal pipe material 40 serves as a reference, but any end portion in a circumferential direction of the metal pipe material 40 in the width direction may serve as a reference.

Here, since the “pipe diameter” and the “plate thickness” are dimensions set in advance when a desired forming product is formed, “pipe diameter” and the “plate thickness” are treated as non-variable parameters. On the other hand, the “current value”, the “pipe spacing”, the “upper die spacing”, and the “lower die spacing” are classified into non-variable parameters and variable parameters depending on scene and condition. For example, during planning of the forming die 2, all of the “current value”, the “pipe spacing”, the “upper die spacing”, and the “lower die spacing” can be treated as variable parameters. For example, when the planning of the forming die 2 is completed and a trial operation is performed, the “current value”, the “upper die spacing”, and the “lower die spacing” can be treated as variable parameters. The “pipe spacing” needs to be treated as a non-variable parameter.

The display device 250 displays non-variable parameters and variable parameters in a visually distinguishable manner. In the examples illustrated in FIGS. 11, 12A, and 12B, the display device 250 displays non-variable parameters in hatched frames, and displays variable parameters in dot-pattern frames. The display device 250 may display parameters on a screen by colors and the like. The display device 250 inserts a value corresponding to each item into a frame corresponding to the item and displays the value.

As described above, even when a parameter can be treated as a variable parameter depending on scene, the display device 250 is capable of displaying the parameter as a non-variable parameter according to a setting by a user. For example, in the example illustrated in FIG. 11, the display device 250 also displays the “upper die spacing”, the “lower die spacing”, and the “current value” as non-variable parameters in addition to the “pipe diameter” and the “plate thickness”, and displays only the “pipe spacing” as a variable parameter. Incidentally, the display device 250 displays an upper limit value of a current value required to prevent plastic deformation of the metal pipe material 40 as the “current value”.

In FIG. 12A, since the positions of the upper die 12 and the lower die 11 are determined in advance, the “upper die spacing”, the “lower die spacing”, and the “pipe spacing” are displayed as non-variable parameters, and only the “current value” is displayed as a variable parameter. On the other hand, in FIG. 12B, since the pipe spacing and the energization current value are determined in advance, the “pipe spacing” and the “current value” are displayed as non-variable parameters, and the “upper die spacing” and the “lower die spacing” are displayed as variable parameters. The display device 250 displays the “upper die spacing” and the “lower die spacing” required to prevent plastic deformation of the metal pipe material 40.

As described above, the display device 250 proposes and displays variable parameters. Namely, the display device 250 inserts values, which can prevent plastic deformation of the metal pipe material 40, into variable parameter frames when non-variable parameters are set to determined values. These values may be computed by the controller 8 (refer to FIG. 10). For example, the controller 8 refers to a database created in advance for values set as non-variable parameters to retrieve suitable values as variable parameters. Alternatively, the controller 8 may calculate suitable values as variable parameters by computation based on values of non-variable parameters.

In addition, in FIGS. 11, 12A, and 12B, the metal pipe material 40 is energized and heated in a state where the metal pipe material 40 is disposed between the upper die 12 and the lower die 11 (namely, inside the forming die 2). However, the metal pipe material 40 may be energized and heated outside the forming die 2. For example, the metal pipe material 40 may be heated outside the forming die 2 using the robot arm as illustrated in FIG. 9, and then the heated metal pipe material 40 may be disposed inside the forming die 2. In this case, both during die planning and during trial operation, the “upper die spacing” and the “lower die spacing” are removed from a parameter list.

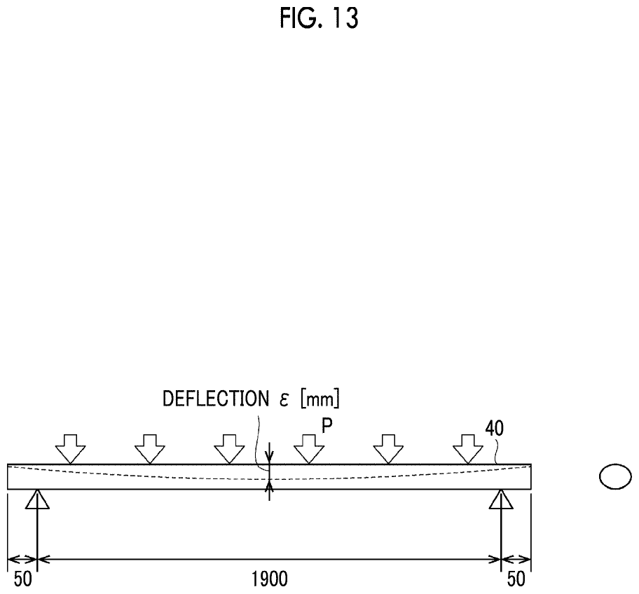

One example of a proposed content of a variable parameter will be described. A description will be given on the premise that the pipe spacing is a variable parameter and other parameters are non-variable parameters. Specifically, “pipe diameter=60.5 mm”, “plate thickness=1.2 mm”, and “current value=9,000 A”. In addition, the target heating temperature is set to 800° C. The Young's modulus of the metal pipe material 40 at 800° C. is 50,000 (N/mm²). In consideration of the model illustrated in FIG. 13, a uniformly distributed load P is computed which allows a deflection ε of a central portion of the metal pipe material 40 to be 1.0 mm or less. Here, when uniformly distributed load P=2 kg (19.6 N), the deflection ε is 1 mm or less. Namely, the controller 8 may compute a pipe spacing at which the uniformly distributed load due to a magnetic field is 19.6 N (approximately 20 N) or less, and propose the value.

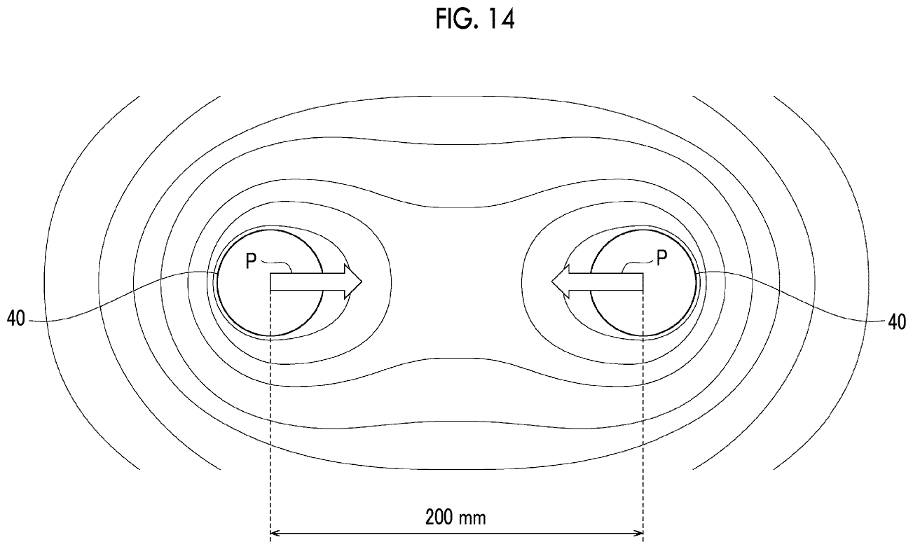

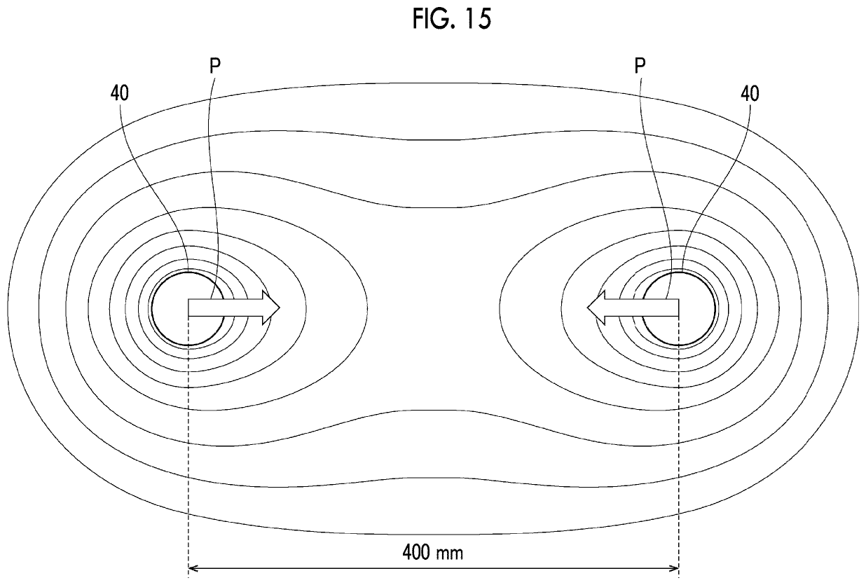

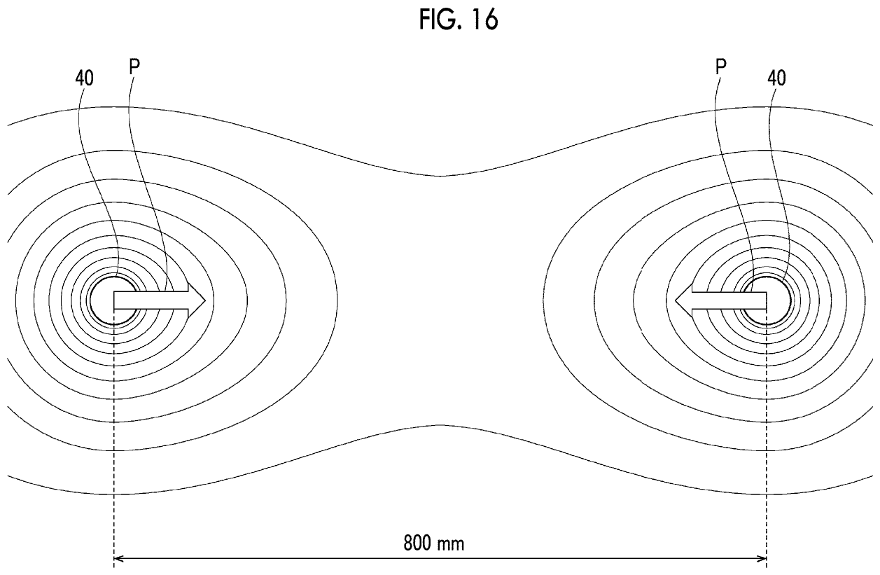

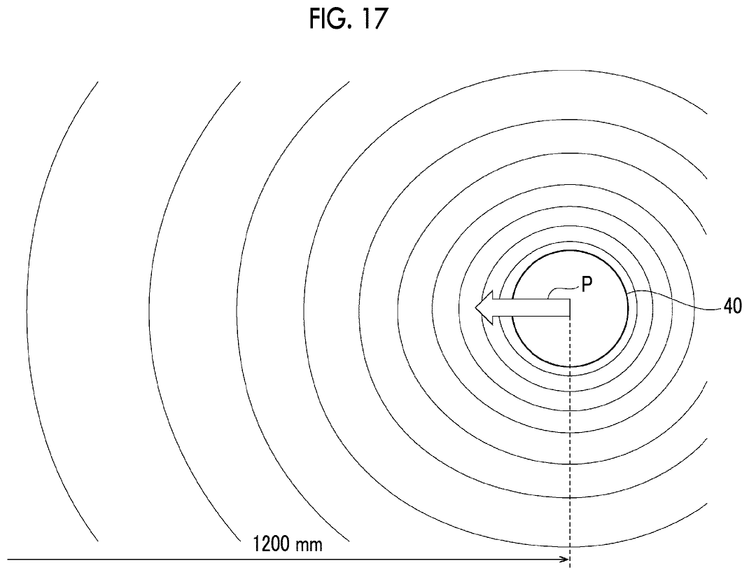

Specifically, when the pipe spacing is set to 200 mm (refer to FIG. 14), the uniformly distributed load P acting on one of the metal pipe materials 40 is 163.4 (>20 N). When the pipe spacing is set to 400 mm (refer to FIG. 15), the uniformly distributed load P acting on one of the metal pipe materials 40 is 81.8 (>20 N). When the pipe spacing is set to 800=(refer to FIG. 16), the uniformly distributed load P acting on one of the metal pipe materials 40 is 39.1 (>20 N). When the pipe spacing is set to 1,200 mm (refer to FIG. 17), the uniformly distributed load P acting on one of the metal pipe materials 40 is 21.8, which is approximately 20 N. Therefore, the display device 250 may propose and display 1,200 mm (or a value slightly larger than 1,200 mm) as the pipe spacing.

Incidentally, the display device 250 may change parameters displayed as non-variable parameters to variable parameters, and accept an input from a user. For example, in the example illustrated in FIG. 11, when the proposed pipe spacing does not meet an intention of a user, the display device 250 may switch the current value from a non-variable parameter to a variable parameter. The display device 250 may propose a new pipe spacing based on the newly set current value.

As described above, the display device 250 proposes and displays variable parameters that are adjustable. Accordingly, when variable parameters are adjusted based on contents proposed by a user, the metal pipe material 40 can be disposed at a position at which the influence of magnetic forces is reduced. Namely, a user can easily and finely adjust the disposition of each component in the field with reference to values proposed by the display device 250. Accordingly, the metal pipe material 40 can be disposed at an appropriate position.

The variable parameter is a parameter that affects a magnetic force acting on the metal material. Accordingly, the magnetic force on the metal pipe material 40 can be easily adjusted by adjusting the variable parameter.

The variable parameter may be a value of a current that energizes the metal pipe material 40 when the metal pipe material 40 is heated. A magnetic force on the metal pipe material can be adjusted by adjusting the value of the current.

The forming device 200 may simultaneously form a plurality of the metal pipe materials 40, and the variable parameter may be a distance between the metal pipe materials 40. Accordingly, magnetic forces acting on the metal pipe materials 40 can be adjusted.

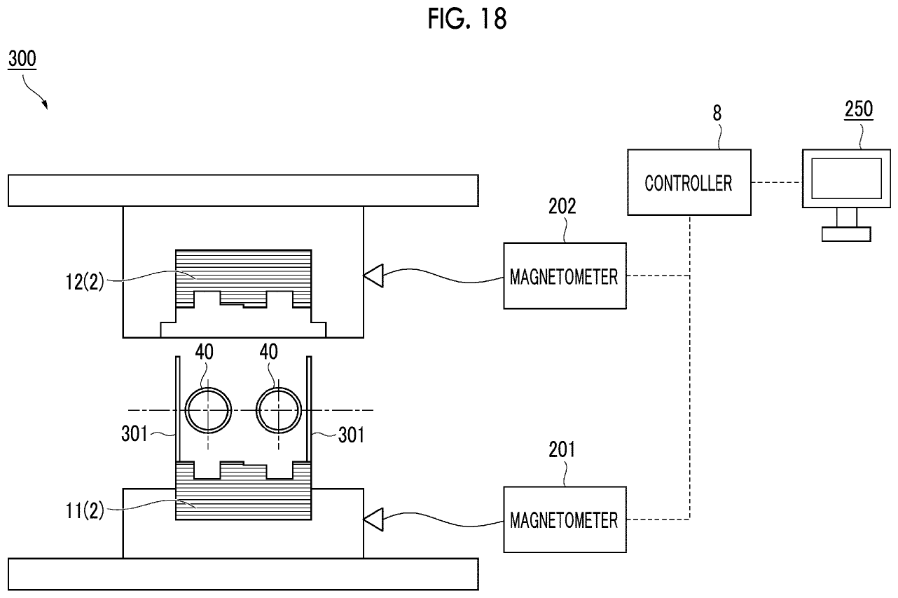

A forming device 300 illustrated in FIG. 18 may be adopted. The forming device 300 includes magnetic force adjusting members 301 that adjust magnetic forces acting on a plurality (two) of the metal pipe materials 40. The magnetic force adjusting members 301 each are made of a metal plate material or the like, and are disposed in the vicinities of the metal pipe materials 40 during heating. The magnetic force adjusting member is provided to extend in the up-down direction and to extend in the longitudinal direction on lateral sides of the metal pipe materials 40 in the width direction. Incidentally, the magnetic force adjusting member 301 may be provided at a position corresponding to a total length of the metal pipe material 40, or may be formed in a partial region of the metal pipe material 40 in the longitudinal direction. It is preferable that the magnetic force adjusting member extends at least above an upper end of the metal pipe material 40 and extends at least below a lower end of the metal pipe material 40 in the up-down direction.

The forming device 300 includes the magnetic force adjusting members 301 that adjust magnetic forces acting on the plurality of metal pipe materials 40. Accordingly, the magnetic force adjusting members 301 are capable of adjusting the magnetic forces acting on the metal pipe materials 40 such that deformation of the metal pipe materials 40 is suppressed. With the above configuration, the metal pipe materials 40 can be disposed at appropriate positions.

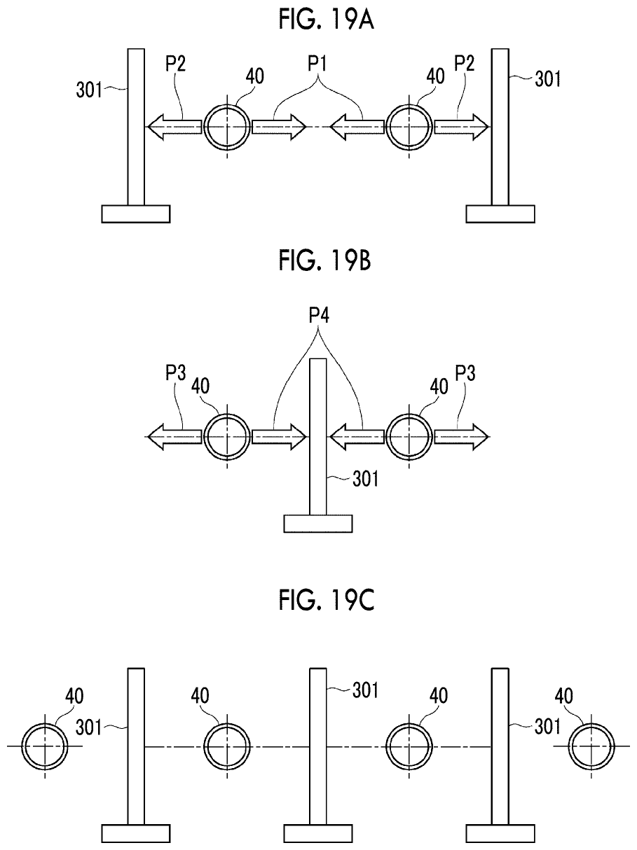

One example of disposition of the magnetic force adjusting member 301 will be described with reference to FIGS. 19A to 19C. As illustrated in FIG. 19A, a pair of the magnetic force adjusting members 301 may be respectively disposed outside a pair of the metal pipe materials 40 in the width direction. FIG. 19A is a disposition example in which currents flow through the metal pipe materials 40 on a left side and a right side in the same direction. In this case, for example, during heating, a force P1 (Lorentz force) to pull the metal pipe material 40 on the left side and the metal pipe material 40 on the right side against each other acts on the metal pipe material 40 on the left side. In the viewpoint of the metal pipe material 40 on the left side, the force P1 toward the right side acts on the metal pipe material 40 on the left side. Here, the magnetic force adjusting member 301 is disposed on a left side of the metal pipe material 40 on the left side. Magnetic force lines are concentrated on the magnetic force adjusting member 301 (magnetic force density is increased), and an attractive force P2 acts between the magnetic force adjusting member 301 on the left side and the metal pipe material 40 on the left side because of the force of a magnetic field. In such a manner, the attractive force P2 can cancel the force P1 to pull the metal pipe materials 40 against each other. Therefore, even when the pair of metal pipe materials 40 are brought close to each other, the magnetic force adjusting members 301 are capable of suppressing plastic deformation inward in the width direction.

In addition, as illustrated in FIG. 19B, the magnetic force adjusting member 301 may be disposed between the pair of metal pipe materials 40. FIG. 19B is a disposition example in which currents flow through the metal pipe materials 40 on the left side and the right side in different directions. In this case, for example, during heating, a force P3 acts on the metal pipe material 40 on the left side in a direction in which the metal pipe material 40 on the left side is pulled away from the metal pipe material 40 on the right side (repulsion direction). From the viewpoint of the metal pipe material 40 on the left side, the force P3 toward the left side acts on the metal pipe material 40 on the left side. Here, the magnetic force adjusting member 301 is disposed between the metal pipe material 40 on the left side and the metal pipe material 40 on the right side. Magnetic force lines are concentrated on the magnetic force adjusting member 301 (magnetic force density is increased), and an attractive force P4 acts between the magnetic force adjusting member 301 at the center and the metal pipe material 40 on the left side because of the force of a magnetic field. In such a manner, the attractive force P4 can cancel the force P3 to cause the metal pipe materials 40 to repel each other. Accordingly, even when the pair of metal pipe materials 40 are brought close to each other, the magnetic force adjusting member 301 is capable of suppressing plastic deformation inward in the width direction.

Incidentally, when four metal pipe materials 40 are arranged, as illustrated in FIG. 19C, the magnetic force adjusting member 301 may be disposed between a pair of the metal pipe materials 40 adjacent to each other. Accordingly, the pair of metal pipe materials 40 adjacent to each other can be disposed close to each other.

Incidentally, since FIG. 18 illustrates disposition when the metal pipe materials 40 are heated inside the forming die 2, the magnetic force adjusting members 301 are also disposed in the vicinity of the forming die 2. However, when the metal pipe materials 40 are heated outside the forming die 2, the magnetic force adjusting members 301 are also disposed outside the forming die 2.

The forming device 300 illustrated in FIG. 18 also includes the display device 250. Therefore, the display device 250 can treat a distance between the magnetic force adjusting member 301 and the metal pipe material 40 as a variable parameter. Accordingly, the magnetic force adjusting members 301 are capable of adjusting the magnetic forces acting on the metal pipe materials 40 such that deformation of the metal pipe materials 40 is suppressed. Both during die planning and during trial operation, the display device 250 can treat the distance between the magnetic force adjusting member 301 and the metal pipe material 40 as a variable parameter. In addition, both when heating is performed inside the forming die 2 and when heating is performed outside, the display device 250 can treat the distance between the magnetic force adjusting member 301 and the metal pipe material 40 as a variable parameter.

Incidentally, in the case of internal heating, since the magnetic force adjusting member 301 is disposed in the vicinity of the forming die 2, the magnetic force adjusting member 301 does not need to be configured not to interfere with the forming die 2, the holders, or the like upon die closing. For example, a groove portion may be formed to accommodate the magnetic force adjusting member 301 upon die closing. A drive mechanism may be provided to retract the magnetic force adjusting member 301 upon die closing.

According to one aspect of the present invention, there is provided a forming device that forms a metal material, the device including: a metal member used to form the heated metal material, and a position adjusting unit that adjusts a position of the metal material. The position adjusting unit adjusts the position of the metal material based on magnetic forces generated in a relationship of the metal member to the metal material.

Such a forming device includes the metal member used to form the metal material, and the position adjusting unit that adjusts the position of the metal material. When the metal material is disposed close to the metal member during forming, the position adjusting unit may generate magnetic forces in the relationship of the metal member to the metal material. In this situation, the position adjusting unit adjusts the position of the metal material based on the magnetic forces generated in the relationship of the metal member to the metal material. Accordingly, the forming device allows the metal material to be disposed at an appropriate position with respect to the metal member used for forming.

The position adjusting unit may adjust the position of the metal material such that the magnetic forces on the metal material are balanced. Accordingly, bending of the metal material caused by the magnetic forces can be suppressed.

The position adjusting unit may adjust the position of the metal material such that the magnetic forces on the metal material are not balanced. In this case, the magnetic forces act on the metal material in such a way to be biased in one direction. Accordingly, the metal material can be bent in a desired direction.

### First Aspect

A forming device that forms a metal pipe material including:

a forming die including a first die and a second die that form the metal pipe material;

a heating unit that energizes the metal pipe material to heat the metal pipe material;

a holding unit that holds the metal pipe material between the first die and the second die; and

a controller that controls operation of the forming die, the heating unit, and the holding unit.

in which the controller causes the first die, the second die, and the metal pipe material to be disposed at a first position at which a force generated between the first die and the metal pipe material and a force generated between the second die and the metal pipe material are balanced, and causes the heating unit to heat the metal pipe material at the first position.

### Second Aspect

The forming device according to the first aspect, in which the controller causes the first die, the second die, and the metal pipe material to be disposed at a second position at which a positional relationship is established in which the metal pipe material is disposed between the first die and the second die and which is different from a positional relationship at the first position.

### Third Aspect

The forming device according to the first or second aspect, in which the holding unit includes a rotating mechanism that rotates the metal pipe material between the first die and the second die.

### Fourth Aspect

The forming device according to the second aspect, in which at the second position, the second die is disposed at a position farther from the metal pipe material than a position of the first die, and

the controller sets the first position such that the second die is closer to the metal pipe material at the first position than at the second position.

### Fifth Aspect

The forming device according to the first aspect, in which the holding unit includes a robot arm that moves the metal pipe material to a space between the first die and the second die from an outside of the forming die,

the robot arm includes the heating unit that heats the metal pipe material in a state where the metal pipe material is held, and

the robot arm disposes the metal pipe material at the first position.

It should be understood that the invention is not limited to the above-described embodiment, but may be modified into various forms on the basis of the spirit of the invention. Additionally, the modifications are included in the scope of the invention.

What is claimed is:

1. A display device for a forming device that forms a heated metal material using a metal member,
wherein the display device proposes and displays a variable parameter that is adjustable.

2. The display device according to claim 1,
wherein the display device displays the variable parameter and a non-variable parameter having a dimension set in advance in a visually distinguishable manner.

3. The display device according to claim 2,
wherein the display device changes a parameter displayed as the variable parameter to the non-variable parameter, or changes a parameter displayed as the non-variable parameter to the variable parameter according to a setting by a user.

4. The display device according to claim 1,
wherein the variable parameter is a parameter that affects a magnetic force acting on the metal material.

5. The display device according to claim 1,
wherein the variable parameter is a value of a current that energizes the metal material when the metal material is heated.

6. The display device according to claim 1,
wherein the forming device simultaneously forms a plurality of the metal materials, and
the variable parameter is a distance between the metal materials.

7. The display device according to claim 1,
wherein the forming device simultaneously forms a plurality of the metal materials,
a magnetic force adjusting member that adjusts magnetic forces acting on the metal materials is disposed between the metal materials, and
the variable parameter is a distance between the magnetic force adjusting member and the metal material.

8. A forming device that forms a heated metal material using a metal member,
wherein the forming device simultaneously forms a plurality of the metal materials, and
the forming device comprises a magnetic force adjusting member that adjusts magnetic forces acting on the plurality of metal materials.

9. The forming device according to claim 8,
wherein the magnetic force adjusting member is made of a metal plate material, and
the magnetic force adjusting member is provided to extend in an up-down direction and to extend in a longitudinal direction on a lateral side of the metal material in a width direction.

10. The forming device according to claim 9,
wherein the magnetic force adjusting member extends above an upper end of the metal material and extends below a lower end of the metal material in the up-down direction.

11. The forming device according to claim 10,
wherein the magnetic force adjusting member is provided in a partial region of the metal material in the longitudinal direction or at a position corresponding to a total length of the metal material.

12. The forming device according to claim 11,
wherein a pair of the magnetic force adjusting members are respectively disposed outside a pair of the metal materials in the width direction.

13. The forming device according to claim 11,
wherein the magnetic force adjusting member is disposed between the pair of the metal materials.

14. The forming device according to claim 11,
wherein the metal member is a forming die,
the metal material is heated inside the forming die, and
the magnetic force adjusting member is disposed inside the forming die.

15. The forming device according to claim 14,
wherein the forming die includes a groove portion for accommodating the magnetic force adjusting member upon die closing.

16. The forming device according to claim 14, further comprising:
a drive mechanism for retracting the magnetic force adjusting member from the forming die upon die closing.

17. The forming device according to claim 11,
wherein the metal member is a forming die,
the metal material is heated outside the forming die, and
the magnetic force adjusting member is disposed outside the forming die.

18. A forming device comprising the display device according to claim 1.
